(19) United States
(12) Patent Application Publication
(10) Pub. No.: US 2010/0321824 A1
(43) Pub. Date: Dec. 23, 2010

(54) MAGNETIC RECORDING HEAD HAVING SECONDARY SUB-GAPS

(76) Inventors: Matthew P. Dugas, St. Paul, MN (US); Gregory L. Wagner, Arden Hills, MN (US); Marlow L. Roberts, Champlin, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 12/829,883

(22) Filed: Jul. 2, 2010

Related U.S. Application Data
(63) Continuation-in-part of application No. 11/061,253, filed on Feb. 18, 2005, now Pat. No. 7,800,862.
(60) Provisional application No. 60/545,423, filed on Feb. 18, 2004.
(60) Provisional application No. 61/222,606, filed on Jul. 2, 2009.
(60) Provisional application No. 61/291,040, filed on Dec. 30, 2009.

(51) Int. Cl. G11B 5/265; G11B 5/78

(52) U.S. Cl. 360/119.06; 360/134; G9B/5.068; G9B/5.291

(57) ABSTRACT

A magnetic head and method for making same which can be used for formatting or writing servo tracks or data on a tape. In one example, the magnetic head may include a magnetic thin film layer; at least one gap defined in the magnetic thin film layer; and at least one secondary sub-gap structure within the magnetic thin film layer, the at least one gap positioned proximate the at least one secondary sub-gap structure. Through the use of the secondary sub-gap structure, the gap (i.e. a record gap or channel) can be made thinner than in conventional heads.

### CROSS-REFERENCE TO RELATED APPLICATIONS

This application is a continuation-in-part of U.S. patent application Ser. No. 11/061,253, entitled “Magnetic Recording Head Having Secondary Sub-Gaps,” filed Feb. 18, 2005, which claims the benefit of U.S. Provisional Patent Application No. 60/545,423, entitled “Dual Sub-Gap Head,” filed on Feb. 18, 2004, and also claims the benefit of U.S. Provisional Patent Application No. 61/222,606, entitled “Thick Film Coupled Thin Film Surface Film Recording Head,” filed Jul. 2, 2009 and U.S. Provisional Patent Application No. 61/291,040, entitled “Thick Film Coupled Thin Film Surface Film Recording Head,” filed Dec. 30, 2009, the disclosures of which are hereby incorporated by reference in their entirety.

### TECHNICAL FIELD

The present disclosure relates generally to magnetic recording heads, such as those made of thin-film materials and ceramic materials. In particular, the present disclosure relates to methods and apparatuses used in writing servo tracks onto a tape surface during production of tape. The recording medium, the tape, is made into cartridges which are used to store massive amounts of information.

### BACKGROUND

Magnetic tape as a data storage medium requires the ability to effectively write and read data to data tracks of the magnetic tape. Many such data tracks typically extend linearly along the length tape and, in part, define tape density. In addition, for providing a controlled movement of tape reading and/or writing heads with respect to the data tape, servo tracks are commonly used which also extend linearly along the length of tape. Servo tracks are typically written in such a way as to span the tape in an efficient manner that maximizes the number of data tracks and minimizes the number of servo tracks for a given tape system. Data reading and writing heads thus typically also include one or more servo read heads. Servo read heads may either be specifically dedicated servo reads heads or they may be data read heads that are operating as servo read heads at a particular track position.

Time Based Servo (TBS) writing, as utilized in state-of-the-art tape magnetic storage systems, uses magnetic transitions written on the tape with at least two non-parallel gap lines, forming a pair of writing gaps. To write these transitions onto the tape, special magnetic recording heads are manufactured. These heads are constructed by means of forming gaps in a surface film magnetic structure. The surface film of the structure is generally parallel to the plane of the recording medium. The magnetic flux is carried horizontally through the film, from one sub-pole member to another sub-pole member, intercepts a gap, and a recording field is generated around the gap which writes transitions onto the magnetic tape.

FIG. 1 illustrates a sectional view of an example of a conventional prior art head 10. A magnetic thin film layer 12 (such as approximately 2 to 3 microns in thickness) is provided having a pair of gaps 14 therein that define a recording feature or channel. Typically, the gaps 14 have a width of approximately 1.5 to 2.0 microns and a height of approximately 2.5 to 3.0 microns. Below the pair of gaps, a primary ceramic sub-gap 16 is provided by the ceramic material between the ferrite portions or poles 18 of the head. The head 10 may be a Type I™ head having a single ferrite channel, such as described in U.S. Pat. No. 5,689,384; or a Type II™ head having multiple ferrite channels such as described in U.S. Pat. No. 6,496,328, the disclosures of which are both incorporated by reference in their entirety.

In future generations of magnetic tape products more servo information will be required per servo frame (higher linear density of the servo signals) and the coercivity of the recording medium (tape) will be larger and, therefore, more head field will be required to write magnetic transitions on the tape medium. With uni-polar pulse recording, as used in current time base servo systems, narrower gaps will be required to record more pulse transitions per linear dimension on the tape. This will result in servo frames with more information per frame as compared to today's conventional products. More servo samples will result in more robust servo channels and the ability to have a much more precise position error signal (PES) parameter that characterizes the servo channel.

These two issues, higher coercivity media and higher servo density (narrower gaps), compete with each other in the design space allotted to the head engineer. Smaller gaps are more easily processed in thinner magnetic films while thicker magnetic films can carry more magnetic flux.

A surface film head has the surface film spanning from one sub-pole member to the other, and the distance of the span is determined by the servo pattern dimension. Typically, such dimensions are on the order of 200 to 300 micrometers and these dimensions are highly dependent upon the gap pattern defined upon the surface film. The magnetic surface film carries the flux to the gaps that are located in the middle of this span. The span of the servo pattern roughly defines the distance between one sub-pole and the other. The servo pattern “sits” inside this distance. Hence, the span of the gap pattern determines the span of the surface film. FIGS. 1 and 8 show schematics of this geometry as it relates to a conventional head.

As stated above, current surface film heads have gaps that are on the order of 1.5 micrometers (urn) and these gaps are processed into magnetic thin films that are one the order of 2.0 to 3 um in thickness. These heads can write higher coercivity media with gaps on the order of 0.75 to 1.5 um. However, new generations of magnetic servo heads may require gaps of from 0.1 um to 0.5 um in width (this is referred to as the gap length in the industry).

Gap aspect ratios of about 3:1 or 4:1 may be produced with certain head manufacturing techniques. However, in order to make gaps on the order of 0.1 to 0.5 um, the magnetic film into which the gaps are made must be no thicker than about 0.3 to 1.5 um in thickness. Experimentally, surface films with gaps on the order of 0.25 to 0.5 um that are processed into surface films of 1 to 1.5 um cannot effectively write onto high coercivity media when these films have a span across a sub-gap of about 150 to 300 um. High coercivity in this case means on the order of 2,750 Oe to 3,000 Oe or greater.

In future generations of magnetic tape using shorter gap lengths (narrower gaps) may be required in combination with higher field strength for writing high coercivity tape media. These conditions combine to require a more efficient flux carrying structure for surface film magnetic recording heads, specifically to conduct magnetic flux across a relatively large distance (the span) from the highly permeable sub-poles to the region of the writing gaps.

Accordingly, as recognized by the present inventors, what is needed is a head having a narrower record gap and a method of making such a head. Further, there exists a need to improve the performance of surface films heads that contain complicated multiple gap structures over a relative large span as compared to the thickness of the surface film. It is against this background that various embodiments of the present disclosure were developed.

### SUMMARY

In light of the above and according to one broad aspect of an embodiment of the disclosure, disclosed herein is a magnetic head which can be used for formatting or writing servo tracks or data on a tape. In one example, the magnetic head may include a magnetic thin film layer or structure; at least one gap defined in the magnetic thin film layer; and at least one secondary sub-gap structure (which may be non-magnetic) within the magnetic thin film layer, the at least one gap positioned proximate the at least one secondary sub-gap structure. Through the use of the secondary sub-gap structure, the gap (i.e. a record gap or channel in the surface of the head) can be made thinner than in conventional heads.

In one example, the at least one secondary gap structure is made of material including SiO2 or Al2O3. There are various examples of dimensions and thicknesses disclosed herein, for example, the magnetic thin film layer may be approximately 3 microns thick in one example, and the at least one gap may be between approximately 0.125 to 0.25 microns wide.

In one embodiment, the at least one secondary gap structure may include a pair of angled side walls and a top surface, and the at least one gap may be positioned on the top surface of the at least one secondary gap structure.

According to another broad aspect of another embodiment of the present disclosure, disclosed herein a magnetic media formatted by a magnetic head, the magnetic head comprising a magnetic thin film layer, at least one gap defined in the magnetic thin film layer, and at least one secondary sub-gap structure within the magnetic thin film layer.

According to another broad aspect of another embodiment of the present disclosure, disclosed herein is a magnetic tape manufactured by a method comprising writing servo information onto the magnetic tape using a servo head. In one example, the servo head may include a magnetic thin film layer, at least one gap defined in the magnetic thin film layer, and at least one secondary sub-gap structure within the magnetic thin film layer, the at least one gap positioned proximate the at least one secondary sub-gap structure.

According to another broad aspect of another embodiment of the present disclosure, disclosed herein is a method for forming a magnetic head having a magnetic thin film layer. In one example, the method may include forming a structure surrounded by the magnetic thin film layer; and forming a gap in the magnetic thin film layer, the gap positioned atop the structure. In one embodiment, the operation of forming a structure within the magnetic thin film layer may include depositing SiO2 material and shaping the SiO2 material, or depositing Al2O3 material and shaping the Al2O3 material, as an example.

According to another broad aspect of another embodiment of the present disclosure, a sub-layer of magnetic material may be added adjacent to the surface of the recording head in a designed manner which enables more flux to be carried to the location of the magnetic recording gaps on the head. This in turn allows for the use of an extremely thin surface films (which may be referred to herein as the main film or the surface film, interchangeably) into which the gaps are processed. Since an extremely thin main surface film is now possible, this in turn allows for extremely narrow gaps to be processed.

According to another broad aspect of another embodiment of the present disclosure, the sub-layer of magnetic material can be made into trenches that are etched into the head substrate. These trenches approximately span from each sub-pole toward the gap region and also may approximately span the region in-between the gaps. In this way, a much thicker film carries more of the flux generated by the system to the gap region.

The head substrate may be made of any means to reveal a sub-pole, sub-gap system upon which a surface film and its associated gaps are to be subsequently processed. Hence, before the main surface film is deposited, another manufacturing step can be inserted. Trenches can be created which span from the sub-pole area into the region near to where the recording gaps are to be processed. The trenches may be created in a precision processes using photolithography and etching techniques. Ion milling is one preferred method to etch the trenches into the substrate. The trenches may be filled with a magnetic material and hence make up the flux carrying capacity that is no longer available with a thinner surface film which will be used to make the narrower gaps. The thickness of the magnetic material filling the trenches can be from about 2.5 to about 10 um. The exact thickness may be determined experimentally or by analytical design.

The substrate, now with precision trenches on the order of about 2.5 to about 10 um deep, may be deposited with a magnetic material which coats into the trenches. The deposition may selectively coat into the trenches but, in many embodiments, will generally be a blanket coating onto the substrate and its surfaces. This deposition will be on the order of the depth of the trenches, in order to fill the trench.

After deposition into the trenches, the substrate surface may be planarized, or contoured if it carries a radius as many heads may have. The point is to make the filled-in trench co-planar, or of the same contiguous contour, with the common slider surface of the recording head.

This process results in a substrate which has thick magnetic thin film flux carriers extending into and toward a region of the substrate that will subsequently have gaps made.

The main or surface film containing the gap patterns may now be processed. The main film deposition is relatively, and in some cases extremely, thin in comparison to the trench film. A film on the order of 0.5 um may be sufficient. The gaps may be formed into the main film by any suitable means including, but not limited to, such means as sputtering and subsequent etching, or by plating up around a gap barrier, or by sputtering over a gap barrier.

Since the main surface film can be extremely thin, on the order of 0.5 um, this will allow for very narrow gaps to be made, on the order of from 0.1 to 0.5 um. Furthermore, since most of the flux is carried by a subsurface magnetic film, the flux delivered to the narrow gaps may be more than sufficient to record very high coercivity media and future generations of media that may have high dynamic coercivity or other parameters suitable for high density recording.

While multiple embodiments are disclosed, still other embodiments of the present disclosure will become apparent to those skilled in the art from the following detailed description, which shows and describes illustrative embodiments of the disclosure. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### DESCRIPTION OF THE DRAWINGS

While the specification concludes with claims particularly pointing out and distinctly claiming the subject matter that is regarded as forming the various embodiments of the present disclosure, it is believed that the embodiments will be better understood from the following description taken in conjunction with the accompanying Figures, in which:

FIG. 1 illustrates a sectional view of a conventional magnetic recording head.

FIG. 2 illustrates a sectional view of a magnetic recording head having a primary sub-gap and a secondary sub-gap, in accordance with one embodiment of the present disclosure.

FIG. 3 illustrates a top view of an example of a head incorporating a primary sub-gap and a secondary sub-gap, in accordance with one embodiment of the present disclosure.

FIG. 4 illustrates a top view of another example of a head incorporating a primary sub-gap and a secondary sub-gap, in accordance with one embodiment of the present disclosure.

FIG. 5 illustrates a top view of another example of a head incorporating a primary sub-gap and a secondary sub-gap, in accordance with one embodiment of the present disclosure.

FIG. 6 illustrates a top view of another example of a head incorporating a primary sub-gap and a secondary sub-gap, in accordance with one embodiment of the present disclosure.

FIG. 7 illustrates an example of operations for forming a head having a secondary sub-gap, in accordance with one embodiment of the present disclosure.

FIG. 8a illustrates a top plan view of a section of a conventional head substrate showing the sub-gap and sub-pole prior to deposition of the surface film.

FIG. 8b illustrates a top plan view of a conventional head showing the gap pattern in the magnetic thin film deposited on the surface of the recording head.

FIG. 8c illustrates a cross-section view of a conventional head, similar to FIG. 1, showing the surface film and the gaps in the surface film containing the recording gaps in relation to the sub-poles.

FIG. 9 illustrates a plan view of the surface of a typical timing based recording head showing a detail of the span of the gap pattern in relation to the sub-gap span between the sub-poles.

FIG. 10a illustrates a top plan view of the secondary magnetic sub-poles substrate, in accordance with one embodiment of the present disclosure.

FIG. 10b illustrates a cross-section view of the secondary magnetic sub-poles substrate, in accordance with one embodiment of the present disclosure.

FIG. 11 illustrates a cross-section of one embodiment of the present disclosure showing the secondary sub-poles, secondary sub-gaps, and the surface film containing the recording gaps.

FIG. 12 illustrates a cross-section of one embodiment of the present disclosure showing a schematic representation of the magnetic field path and recording field.

FIG. 13 illustrates an example of process operations for forming a head having a secondary sub-gap, in accordance with one embodiment of the present disclosure.

FIG. 14 illustrates another example of process operations for forming a head having a secondary sub-gap, in accordance with an embodiment of the present disclosure.

FIG. 15a illustrates a top plan view of the secondary magnetic sub-poles substrate, in accordance with an embodiment of the present disclosure.

FIG. 15b illustrates a cross-section view of the secondary magnetic sub-poles substrate, in accordance with an embodiment of the present disclosure.

FIG. 16 illustrates a cross-section of another embodiment of the present disclosure showing the secondary sub-poles, secondary sub-gaps and the surface film containing the recording gaps.

FIG. 17 illustrates a schematic diagram showing the use of the head in formatting a tape medium on a production servo formatter recording deck.

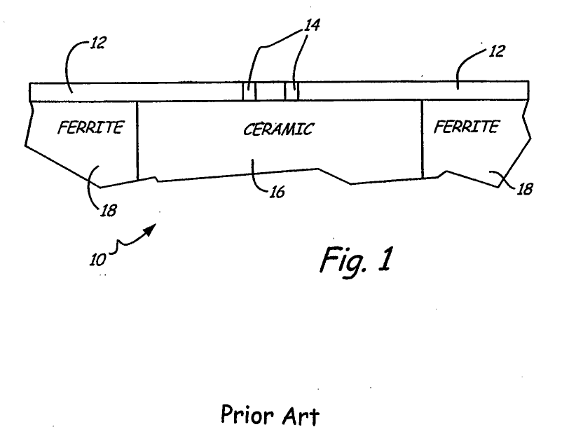

### DETAILED DESCRIPTION

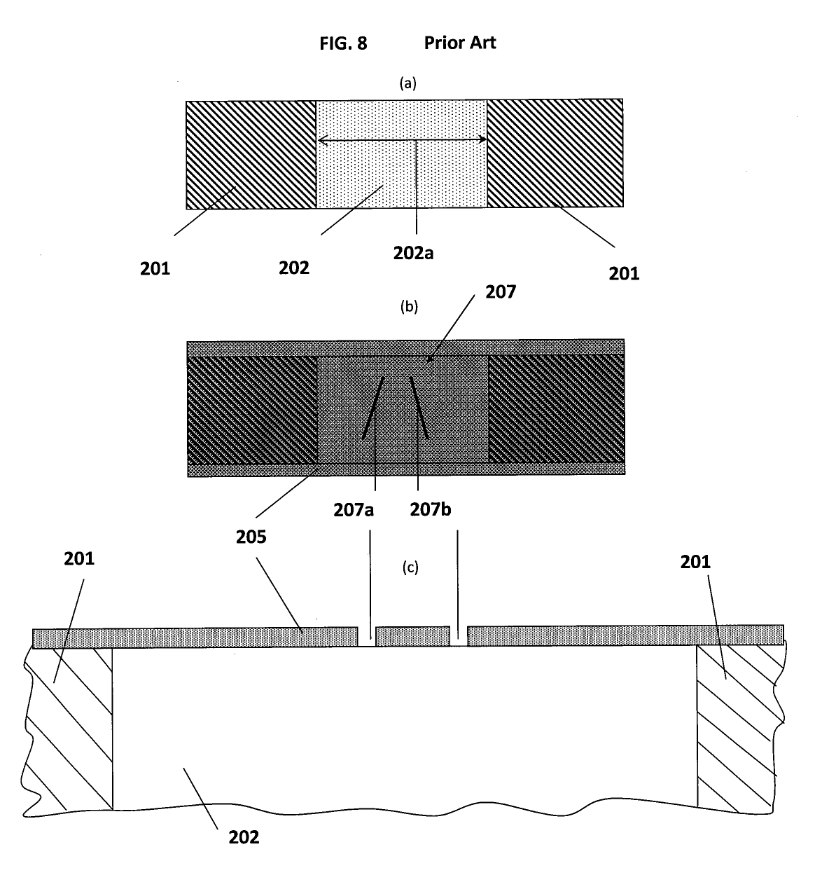

The basic features of a surface film recording head, in particular those used in timing based servo systems, are shown in FIGS. 8. Particularly, in general, a sub-gap 202 is disposed between two sub-poles 201. These terms are used to distinguish these features from the actual recording poles and gaps which perform the recording. In such heads, for a given polarity, the magnetic flux is driven from one sub-pole to another, intercepting gaps along the way. The length of the sub-gap 202a, as shown in FIG. 8a, in the recording direction, or down track direction, is on the order of from 150 um to 300 um. Hence, a thin film 205 should span the distance 202a and should carry flux to the recording gaps 207. This is shown in the plan view of FIG. 8b, where the gaps 207a and 207b are shown as lines for scaling reasons. A further detail of this is shown in FIG. 8c. In current generation servo heads, the thin film 205 is on the order of from 1.5 to 3.0 um in thickness and this in turn limits how small gaps 207a, 207b, can be made depending on the processes used to make the film and its associated recording gaps.

For example, if the gaps are made by plating up a magnetic material around a photo-resist structure, the line widths or gap widths (“gaps length” is the term in data storage parlance for the length of the gap in the recording direction) are determined by the resolution of the photolithographic process. Typically, photolithographic limits are on the order of 1 um with commonly available laboratory mask aligners, and these can be improved to about 0.7 um with the use of shorter wave length optics. Exotic photolithography processes may also be used, such as the pattern stepper technology of semiconductor industry, but these systems are extremely expensive and would not be economical to use on small volume production of recording heads. Assuming there are no limitations on the equipment being used to produce the pattern, the arguments over gap aspect ratios may only be relaxed but not completely eliminated. There still remains the need to conduct more flux to ever narrower recording gaps. If the head is used as a read head, then the argument is not one of write flux conductance but rather read back efficiency, and this mode of operation, as a read head, is likewise improved with lower reluctance magnetic path lengths of this disclosure.

When a magnetic head is energized, flux is carried through the highly permeable sub-poles until it reaches the sub-gap. When the flux reaches the sub-gap and encounters the non-magnetic sub-gap structure, a certain percentage of the magnetic flux is coupled into the surface film. This flux is then carried through the surface film until it reaches the magnetic recording gap. The magnetic flux, or to be more precise, a certain percentage of the magnetic flux, will then energize the space around the magnetic recording gap thus writing magnetic transitions (data) into the magnetic tape media passing above the recording gaps, according to the current energizing the head structure.

The strength of the magnetic field generated around the recording gaps will depend on the amount of flux which intercepts them. Hence, one restriction on the strength of the magnetic field generated is the thickness, of the surface film. Another restriction will be the magnetic moment density of the magnetic film. A thicker film, or higher moment density film, will be able to carry more flux. However, there are processing limitations which restrict the aspect ratio of depth to width than can be achieved in forming functional magnetic gaps in the surface film. This means that a thicker film will limit the process capability in making very narrow gaps and may preclude certain narrow gaps from being made well, or at all. There are also physical limitations on the magnetic moment density of magnetic thin film materials; this is an intrinsic property of the material of choice. Hence, once a high moment density magnetic thin film is chosen, such as FeN or CoFe or other similar high permeability thin films, the efficiency of the write head is based on geometry.

As it may not be possible to simply increase the film thickness, to deliver more flux, and process increasingly narrower (shorter) recording gaps into those thicker films, as may be required for writing magnetic media systems using a surface film heads, we are presented with a design problem. In particular, with the multiple gaps structures made into film as is required by complex servo schemes such as timing based servo systems, with the associated large spans of the gap pattern, the design problem may be solved with various embodiments of this disclosure.

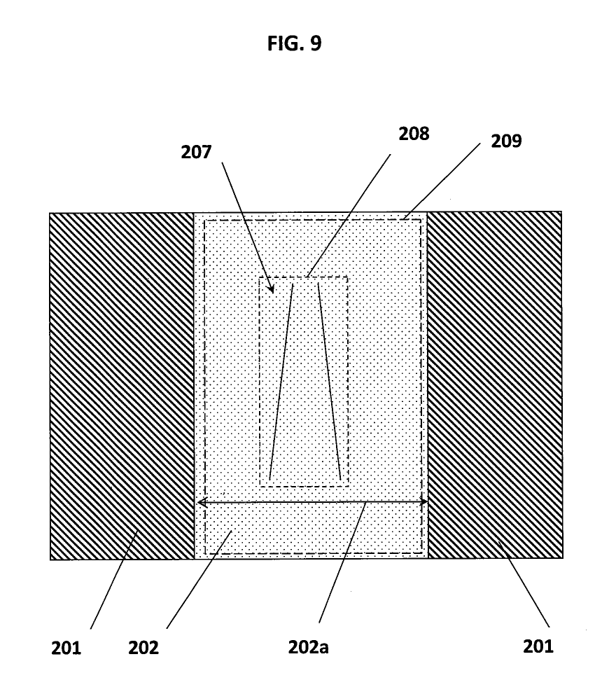

The arguments based around improved efficiency and reduced reluctance are fundamentally raised by the nature of a surface film recording head and by timing based surface film recording heads in particular. FIG. 9 illustrates the case. The sub-gap 202 and the sub-poles 201 are shown in relation to the gap pattern 207. The thin film, the surface film 205 which contains the gap pattern 207, spans from one sub-pole to the other and contains the entire gap pattern 207 within it. The gap pattern 207 is entirely arbitrary and may be composed of at least two non-parallel gaps as shown in FIG. 9 for timing based recording gaps. Other gap patterns such as erase gaps, read gaps, and write gaps, in a general sense, are to be considered within the scope of the disclosure. In the case of multiple gaps, the gaps have an X and Y dimensional span 208 as indicated by the dotted line 208 bordering the gap pattern 207. Since the thin film containing the gaps must span from one sub-pole 201 to the other sub-pole 201, in order to have the magnetic flux couple the gaps proper, there exists another span 209 which is called the sub-gap span. The sub-gap span 209 will be slightly larger than the gap pattern span 208 as indicated in FIG. 9. It is noted here that the thin film spanning the sub-gap region may not only be rectangular but may also be of slanted and focusing designs; all are to be considered consistent with the various embodiments of this disclosure.

Flux conductance from the sub-poles across span 208, and energizing the recording gaps 207, is dependent upon the span 209 of the recording gaps 207. For example, a four gap head will generally be wider than a corresponding two gap head resulting in a larger gap span 208 and therefore the sub-gap span 209 may also be correspondingly larger. In another example, if the angles of the gaps are made larger, a larger gap span 209 also results. If narrower gaps are required for a certain format linear density, then the surface film 205 (main film) must be made correspondingly thinner for a given gap making process, as previously discussed. This in turn limits the flux that can be conducted across the spans 208, 209. Hence, the extreme end of the design space is that of large gap spans coupled with very narrow gap requirements.

In order to solve the dilemma of processing ever narrower gaps and conducting ever more flux to those gaps, more flux conductance material is added into the substrate in a designed manner before the gap containing main surface film 105 is processed. This in turn allows for the use of an extremely thin main surface film (which may be referred to herein as the main film or the surface film, interchangeably) into which the gaps are processed. By the use of the auxiliary and additive flux conducting film, the film made into the trenches as described, an extremely thin main surface film 105 is now possible, and in turn allows for extremely narrow gaps 107 to be processed more easily into it.

Particularly, in this disclosure, a sub-layer of magnetic film is added in a designed manner which enables more flux to be carried to the location of the magnetic recording writing gaps on the head. This allows for the main gap carrying film, the main surface film of the head, to be extremely thin, on the order of 0.25 to 1.0 um, and may thereby allow easy processing of narrower gaps, on the order of 0.1 to 0.5 um, and also for these gap to be written with a higher write field.

It may be important to note that the sub-gap, sub-pole substrate to which this disclosure may apply to is not limited to that of the type in the prior art shown but may also be applied to any surface film head, and in particular may be particularly useful when applied to surface film heads which carry multiple gap structures such as those used in time based servo recording formats.

Accordingly, disclosed herein are magnetic head structures for use with a tape medium, and method for making such magnetic heads. The magnetic heads may be write heads or read heads, for instance used to write servo patterns or other data on a magnetic tape medium. Generally, embodiments of the disclosure provide for forming small record gaps on the surface of such heads. Various embodiments of the disclosure will now be described.

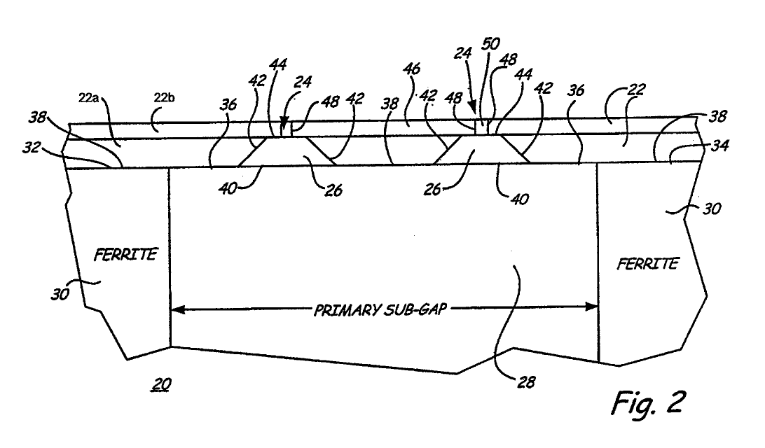

FIG. 2 illustrates a sectional view of one example of a head 20, in accordance with one embodiment of the present disclosure. In one example, a head 20 may include a magnetic thin film layer or structure 22 (22a and 22b) having one or more gaps 24 (also referred to herein as record gaps, channels, or arbitrary gap features) therein, the one or more gaps 24 positioned upon or proximate to one or more secondary sub-gap structures 26, also within the magnetic thin film layer 22 and located on a primary sub-gap surface 28. Through the use of secondary sub-gap structures 26, the record gaps 24 can be made much more narrower than conventional surface film recording heads and still maintain the same reluctance of the total magnetic path length of conventional surface film head designs.

As shown in FIG. 2, the head 20 includes two sub-poles 30, shown made of ferrite in this embodiment, which border a primary sub-gap region 28. While in this example, the first and second poles 30 are made of ferrite, the sub-poles 30 may also be made of thin film materials such as NiFe or other similar soft magnetic materials. The primary sub-gap region 28 may be made of bulk ceramic materials or thick thin film non-magnetic materials and may have differing dimensions depending on the particular implementation. As an example only, the primary sub-gap region 28 may have a width of approximately 10 to 300 microns between the sub-pole regions 30 of the head 20.

In one embodiment, the top surfaces 32, 34, 36 of the first and second ferrite regions 30 and the primary sub-gap region 28 form an upper surface or plane 38. Upon the upper surface 38, a magnetic thin film layer 22a is provided having one or more secondary sub-gap structures 26 defined therein, each secondary sub-gap structure 26 having a record gap 24 associated therewith and defined in the magnetic thin film material 22b. The secondary sub-gap structures may be non-magnetic.

In the example of FIG. 2, a secondary sub-gap structure 26 may include a bottom surface 40, a pair of side walls 42, typically with a slight angle, and a top surface 44 defining a plane. In one example, the bottom surface 40 of the secondary sub-gap 26 is wider than the top surface 44 of the secondary sub-gap, thereby retaining the thick and efficient flux conduction for the majority of the magnetic thin film while focusing the flux to the recording gaps 24 which are defined in the smaller thinner magnetic layer 22b of the magnetic layer 22. The thinner magnetic layer 22b will have a thickness that can define the height of recording gaps 24. In this way, the recording gaps 24 may be made much smaller in width by application of the aspect ratio rules of a particular gap definition.

The top surface 44 of the secondary sub-gap structure 26 defines a mesa, shelf, plateau or plane (these terms are used interchangeably) upon which the record gap 24 of the head 20 can be defined. The record gap 24 is positioned on the shelf 44 of the secondary sub-gap 26, the record gap 24 having generally parallel walls 48 defining an opening or cavity 50 between portions of the magnetic thin film layer 22. Preferably, the record gap 24 defines an empty cavity without any material within the gap 24. The record gap 24 may define the recording pattern or recording feature of a recording head. The stray field flux of the gap 24 records onto the tape medium.

In one example, a secondary sub-gap structure 26 may be formed by depositing materials upon the upper surface 38 of a conventional head substrate during manufacturing. For instance, materials such as SiO2, Al2O3 or other materials (including non-magnetic materials) may be deposited along the upper surface 38 of the head 20 proximate the surface 36 of the primary sub-gap 28 to form one or more secondary sub-gap structures 26. During the deposition process, the shape of the secondary sub-gap structure 26 may be defined depending on the particular implementation. It is understood that the cross-sectional shape of a secondary sub-gap structure 26 as shown in FIG. 2 is provided by way of example only, and the secondary sub-gap structure 26 may have other shapes, such as non-angled side walls 42, if desired.

In one example, the width of the shelf 44 of a secondary sub-gap structure 26 may be approximately two to three microns, while the bottom surface or base 40 of the secondary sub-gap structure 26 may be approximately 6 to 7 microns in width, depending upon the particular implementation. In one example, the height of the secondary sub-gap structure 26 is approximately 2.5 microns, while the width of the record gap 24 is approximately 0.25 microns in the thinner magnetic layer 46. In another example, the record gap 24 may be approximately 0.1 to 0.25 microns wide, although larger record gaps 24 can be formed if desired. It is understood that other dimensions may be realized using embodiments of the present disclosure.

For instance, the record gap 24 and the thinner magnetic layer 46 can be between approximately 0.1 to 0.5 microns in height (in contrast with some conventional gaps which are approximately 2.0 to 3.0 microns in height) and hence, using processing techniques having a 2:1 or 3:1 aspect ratio, a gap width of about 0.1 microns to 0.25 microns may be achieved. Other processing techniques and technologies may be employed.

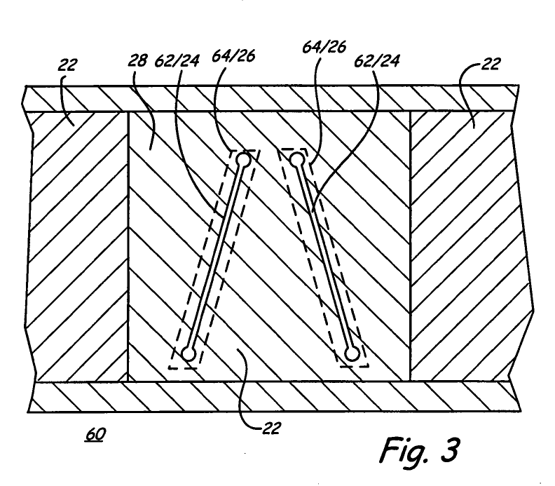

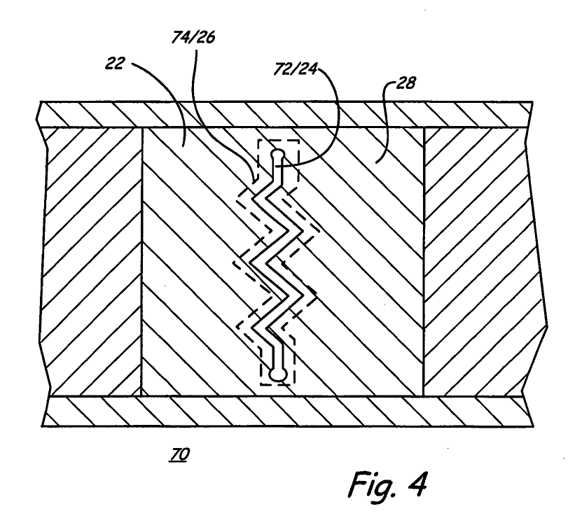

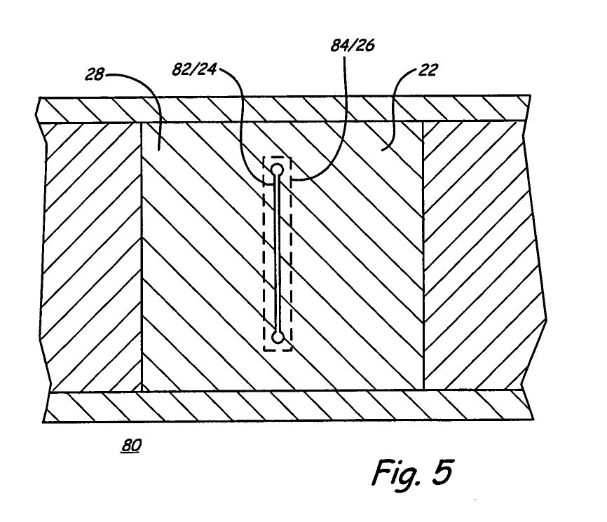

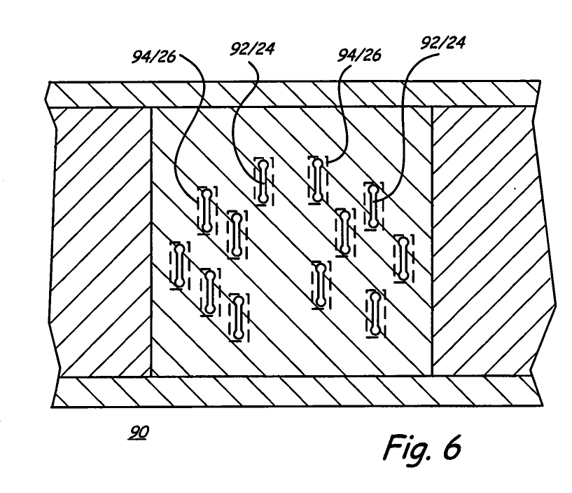

One or more aspects of the present disclosure can be implemented in different heads (such as write heads, servo write heads, or read heads) having various different channel/arbitrary gaps patterns, including complex gap patterns. FIGS. 3-6 illustrate a few such examples. FIG. 3 illustrates an example of a top view of a head 60 having a pair of angled record gaps 62/24, wherein the record gaps 62/24 have a secondary sub-gap 64/26 shown via the dotted lines. FIG. 4 illustrates another example of a record head 70, wherein the record gap feature 72/24 is generally a 45 degree zigzag shape, such as for use in an azimuthal servo-write channel, wherein the record gap 72/24 has a secondary sub-gap 74/26 shown via the dotted lines, in accordance with one embodiment of the present disclosure. FIG. 5 illustrates another example of a top view of a simple erase or amplitude write channel 82/24 of a record head 80, wherein the record gap 82/24 has a secondary sub-gap 84/26 shown via the dotted lines, in accordance with one embodiment of the present disclosure. FIG. 6 illustrates another example of a top view of a head 90, having a plurality of recording gaps 92/24 distributed for use as a stepped time base servo head, wherein the record gaps 92/24 have a secondary sub-gap 94/26 shown via the dotted lines.

It is understood that the examples of FIGS. 3-6 are provided as examples only, and that one or more features of embodiments of the present disclosure may be incorporated into different heads having different channel designs.

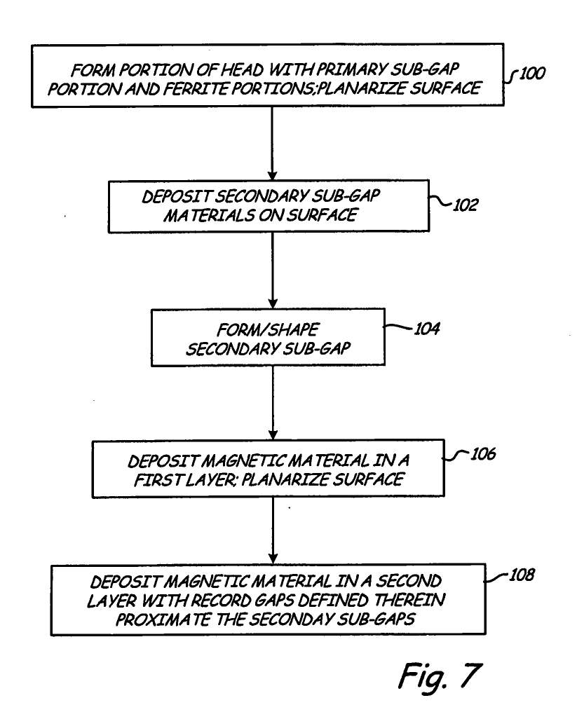

FIG. 7 illustrates an example of operations for forming a head having a secondary sub-gap structure, in accordance with one embodiment of the present disclosure. In one embodiment, a method for forming a magnetic head having a magnetic thin film layer includes forming a structure, preferably non-magnetic, surrounded by the magnetic thin film layer, and forming a gap in the magnetic thin film layer, the gap positioned atop the structure.

In one example and as shown in FIG. 7, at operation 100 a portion of the head is formed with a two or more ferrite portions and a primary sub-gap formed therebetween of a conventional material such as ceramic. For instance, operation 100 may result in a ferrite-ceramic-ferrite structure, and the surface of the ferrite-ceramic-ferrite structure may be planarized or contoured as desired.

At operation 102, a material for forming a secondary sub-gap structure is deposited on the structure of operation 100, preferably on the surface of the ceramic primary sub-gap of the structure. The deposited material may be SiO2, AlO3, or other non-magnetic materials. The deposition of this material may be by sputtering or other well-known deposition processes.

At operation 104, the secondary-sub gap material deposited by operation 102 is processed. Operation 104 may include photo-patterning (i.e., applying photo-resist) to the secondary sub-gap material for the purpose of patterning the sub-gap precisely resulting in etching the secondary sub-gap material into a desired shape, for example etching the side walls of the secondary sub-gap. This may be done by broad beam ion milling, among other means.

At operation 106, a first layer of magnetic material (i.e., magnetic thin film) may be deposited. In one example, the first layer is applied to a thickness which is approximately equal to or slightly greater than the height of the secondary sub-gaps. The first layer of magnetic material may be applied by conventional techniques such as sputtering or plating or other conventional techniques. The first magnetic layer may then be planarized which leaves the top surface of the secondary sub-gap exposed and relatively smooth.

At operation 108, a second layer of magnetic material (i.e., magnetic thin film) is deposited on top of the first magnetic material layer and on top of the secondary sub-gap structures. The second layer of magnetic material may be applied by conventional techniques such as sputtering or plating or other conventional techniques.

The gaps are formed in the second layer of magnetic material, preferably defined on or proximate to the secondary sub-gap structures. The gap patterns of second magnetic layer may made or defined by subtractive etching methods such as a) focused Ion beam etching (for instance, as described in U.S. Pat. No. 6,269,533 entitled “Method Of Making A Patterned Magnetic Recording Head,” the disclosure of which is hereby incorporated by reference herein in its entirety); b) broad beam ion milling; or c) wet chemical etching.

In another example, the gaps in the second layer of magnetic material can be formed or defined by plating the pattern up or sputtering down the pattern, such as by a) plating up the second magnetic layer around a predefined photo-resist gap pattern, and the photo-resist is removed after the plating operation; or b) sputtering the second magnetic layer down, over and around a predefined positive gap pattern and removing or lapping back the over-sputtered positive gap structure.

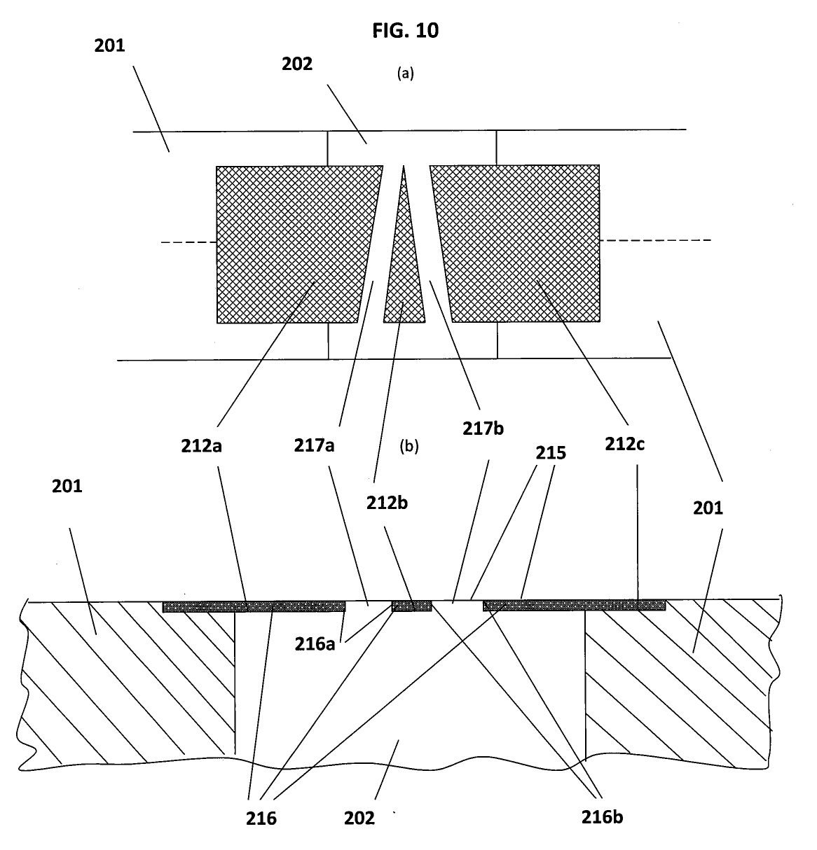

In another embodiment, shown in FIG. 10a, one or more trenches 212 (e.g., 212a, 212b, 212c) may be made into the substrate of the recording head. This can be done with processes such as, but not limited to, photolithography and ion-milling to create trenches on the order of 2.5 to 10 um in depth, depending on the exact design of the entire head. The exact depth of these trenches 212 may depend on a number of parameters that are specific to the recording system as a whole and in no way serves as a limitation on the disclosure. Once the trenches have been made, a magnetic film 216 can be deposited onto the substrate such that the trenches are practically filled with the deposited material. If the deposition is a blanket deposition, as will most often be the case, then the head substrate can be polished to form a contiguous surface or contour. The head may have a radius contour or it may have a flat contour. In any case, in the context of this disclosure to say that the head substrate is made “planar” or is “planarized” may include that the head is contiguous across its surface 215 (contour) after the trenches have been filled in with the deposited secondary sub-pole magnetic film 216. Hence, once the film and substrate system are planarized, typically by a lapping or polishing process, the structure shown in the cross section of FIG. 10b can be realized. As shown in FIG. 10b, secondary sub-gap regions 217a and 217b are formed, each corresponding to a region where the gaps will be subsequently made above in the main film, which has yet to be deposited. As shown specifically in FIG. 10b, the trenches 212 have been filed with magnetic film 216, the auxiliary flux carrying film, and thereby formed secondary sub-pole sets 216a and 216b, each driving the flux into the associated secondary sub-gap region 217a and 217b.

This process may result in a substrate which has relatively thick magnetic thin film flux carriers 216 (auxiliary flux carrying film) extending into and toward a region of the substrate that will subsequently have gaps made. The advantages of this disclosure may be equally applied to any head construction from ferrite/ceramic structures, ferrite/glass structure, and also to pure thin film head structures. The application may be applied to any variation of surface film head, and in particular, may be applied to multiple gap containing surface film heads such as those used in timing based recording which have relatively large gap spans 208. The angular trench 212b feature shown in-between the two gaps 207a and 207b of FIG. 10a may not be required and may be eliminated with certain gap pattern designs, and thus its presence or absence is to be considered entirely within the scope of this disclosure. Also considered fully within the scope of this disclosure are systems of three gaps, four gaps, and any number of gaps that may be a part of the overall gap pattern.

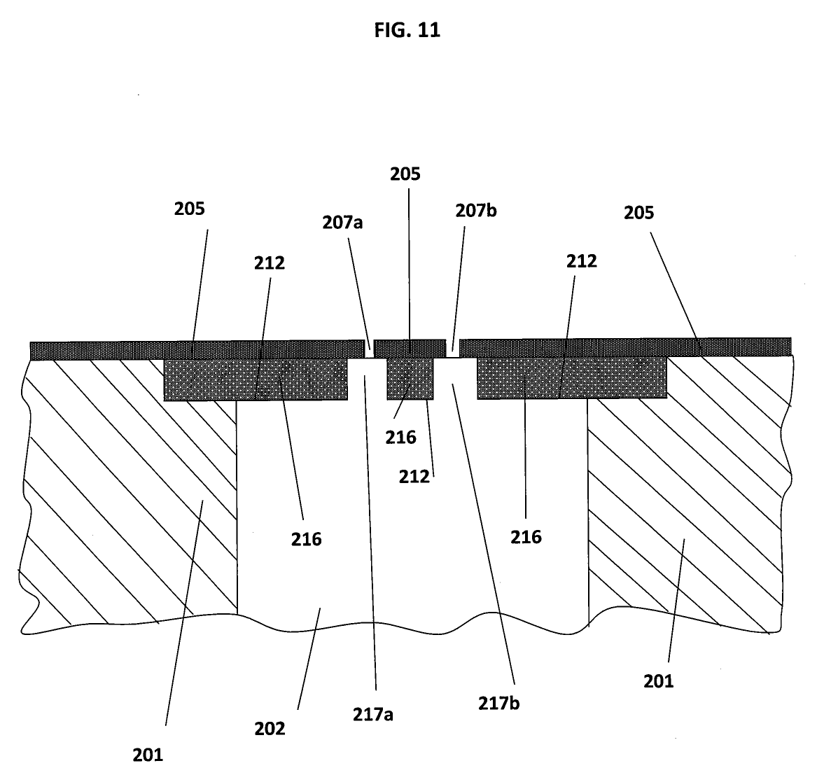

As shown in FIG. 11, the head may now be further processed by completing the main or surface film 205 containing the gap patterns 207a and 207b, generally in accordance with the processes described above or as done with conventional recording heads. The main film deposition may now be made relatively, and in some cases extremely, thin in comparison to the trench film; a film on the order of 0.5 um may be entirely sufficient if the secondary sub-gap is sufficiently small. The gaps may be made into the main film of the head by means of sputtering and subsequent etching, or by plating up around a gap barrier, or by sputtering over a gap barrier, etc.

Since the main surface film is generally extremely thin, on the order of 0.5 um, this will allow for very narrow gaps to be made, on the order of from 0.1 um to 0.5 um. Furthermore, since most of the flux is carried by the sub-surface magnetic film 216, the flux delivered to the narrow gaps should be more than sufficient to record very high coercivity media. The resultant device of this disclosure can be a highly efficient surface film head with secondary sub-poles 216 and secondary sub-gaps 217.

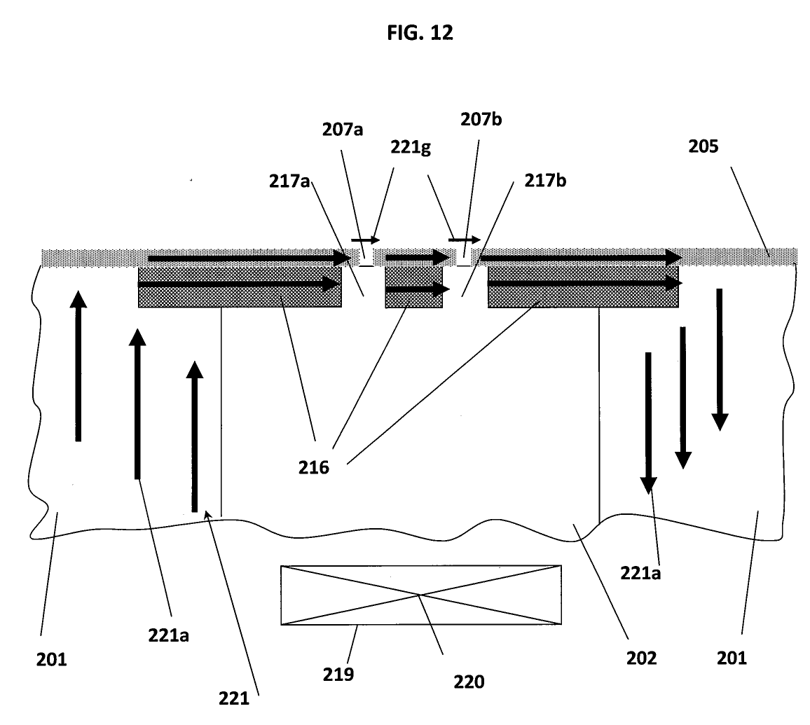

FIG. 12 is a schematic diagram of the general magnetic field 221 with components 221a and 221g. Magnetic field components 221a are associated with the sub-poles, and magnetic field components 221g are that which form the head recording field above the recording gaps at the surface of the head. A coil member 219 may be of any construction, may be multiple coils or a single coil, and may be a thin film coil or a hand placed wire wound coil, and all are within the scope of this disclosure. The coils' current polarity 220 is shown into the plane resulting in the magnetic field 221 in the direction indicated.

With reference to FIG. 12, the flux being carried by the permeable sub-pole 201 will couple into the thin film filled-in trench sub-layer. This in turn can energize the trench film 216 and the main film 205. As can be seen in FIG. 12, by forming the magnetically filled-in trenches into the substrate, the thickness of the magnetic film which carries the flux to the gaps has been effectively increased. The auxiliary sub-poles elements 216 are designed in such a manner as to carry more flux into the near vicinity of the magnetic recording gaps 207a and 207b. This enables designed structures which carry the flux in a controllable manner, and can result in uniform or substantially uniform flux reaching generally the entirety of the recording gap structure. The structures of this disclosure may be applied to a wide variety of arbitrary gap pattern designs to increase the performance of those designs.

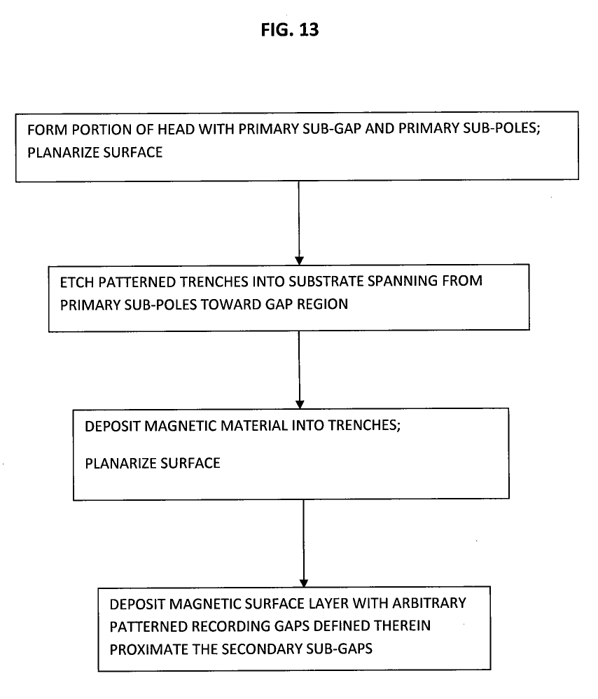

FIG. 13 illustrates one embodiment of a general process flow for the method of making the above embodiment using patterned trenches filled with the magnetic sub-poles.

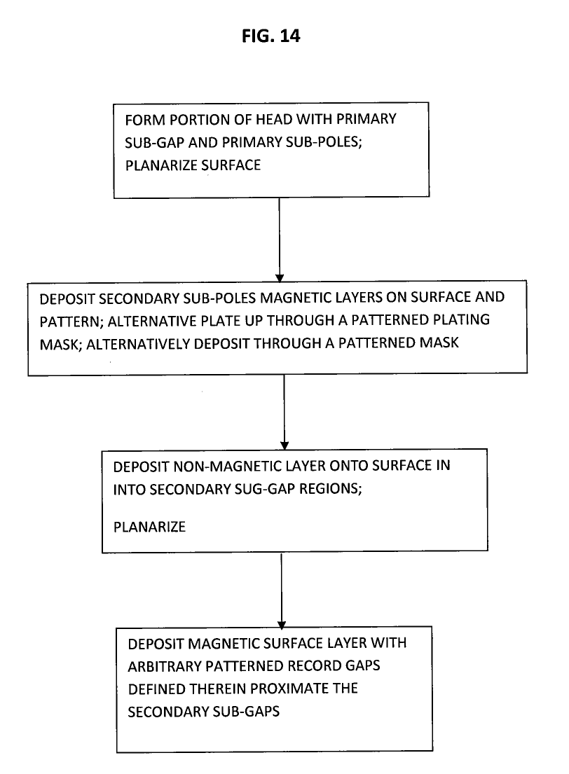

An alternative embodiment to this process is that of depositing the relatively thick layer magnetic sub-poles on the surface of the primary sub-gap sub-pole substrate and then patterning them into the desired shape. This could also be done in a patterned plating process or various other means to achieve a patterned sub-pole on the surface of the head substrate. This process is generally laid out in FIG. 14, which illustrates one embodiment of this general method which utilizes the process of a deposited and patterned secondary sub-pole layered on the substrate surface, as opposed to being deposited into patterned trenches.

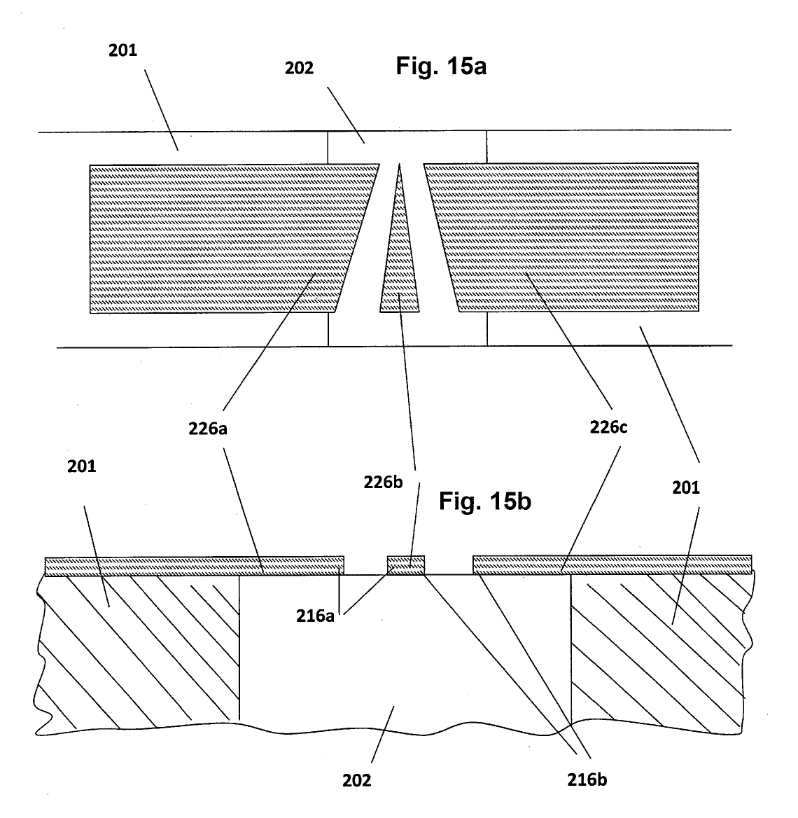

FIG. 15 illustrates an embodiment made using the process of making a patterned sub-pole directly on the primary substrate according to FIG. 14. The features are similar to that of FIG. 10 with the exception that sub-pole features 216 (e.g., 216a, 216b, 216c) of FIG. 10 are now on the primary surface and labeled as 226 (e.g., 226a, 226b, 226c) in FIG. 15.

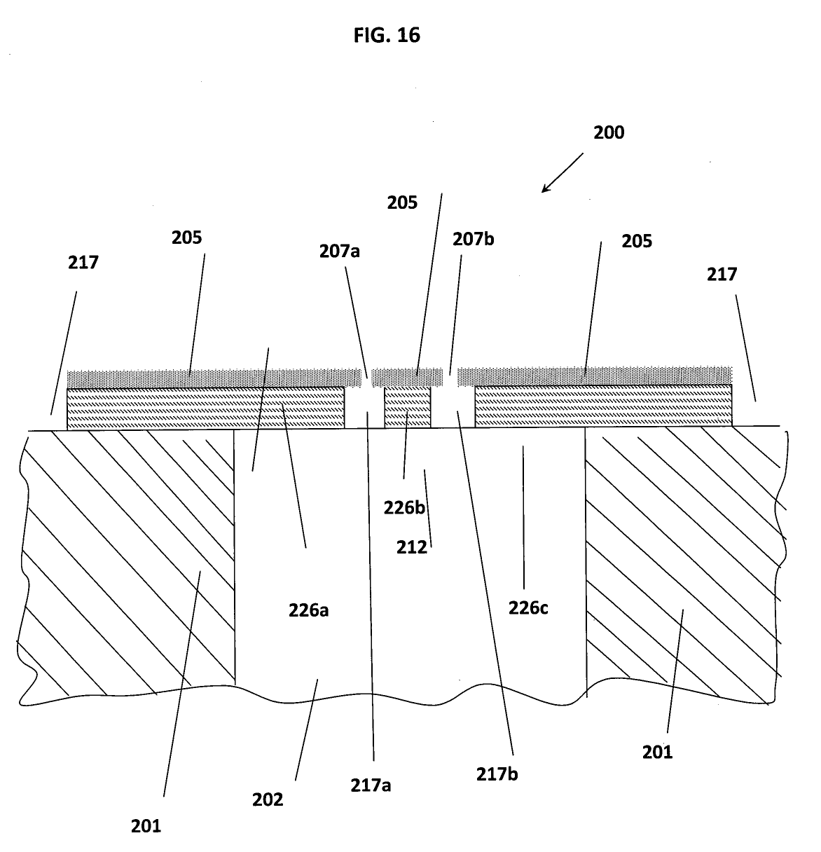

FIG. 16 illustrates a complete, or substantially complete head of one embodiment of this method. In FIG. 16, a general non-magnetic layer 217 may be deposited on the primary substrate and sub-pole features 226. Non-magnetic layer 217 may have regions 217a and 217b forming the secondary sub-gaps. The non-magnetic layer 217 may be planarized to form a surface suitable for the deposition of the surface magnetic film layer 205 which contains the arbitrary recording gaps, and may be processed as described above.

Variations and combinations of the above described methods of manufacture and embodiments are to be considered fully within the scope of the present disclosure.

As the effective thickness of the surface film, and the ability to carry flux to the recording gaps, has been increased, the magnitude of the field generated by the recording gaps is also increased. In addition, the greater film thickness or the film in the trenches effectively reduces the magnetic resistance of the surface film structure. This creates a more efficient writing head and will enable a faster response when energizing the head. Furthermore, the thicker flux transport film deposited in the trenches allow for a very thin main film which in turn allows for the processing of very narrow gaps in the thinner main film. As a total result of the system, extremely narrow gaps on the order of 0.5 micrometer can write extremely high coercivity media.

The recording head of this disclosure in one embodiment is that of a servo format writing head, but it may also serve well as a servo read or verification head. As a verification head, it may be a full band verification head or it may be a partial band verification head. As a writing head, the coil system can be optimized to deliver current in the form of ampere-turns sufficient to record transitions upon the media. As a read back or verification head, the coil system can be optimized to obtain a high read-back voltage from the transitions made into the media. Other embodiments may include, without limitation, data record and read heads.

The recording head in another embodiments as a format write or format verification head is used on a tape formatting deck. The tape formatting deck is essentially a very large tape recording machine that writes servo signals upon large reels of data tape. These large reels are sometimes referred to as pancakes. Each large reel or pancake is formatted, typically in a single pass, and can use various heads such as a servo write head, a servo verification head, a position error servo checker head and may include a pre-erase head, such as but not limited to that described in U.S. Pat. No. 7,283,317, which is incorporated herein by reference in its entirety, or may include a bulk DC-erase head or magnet.

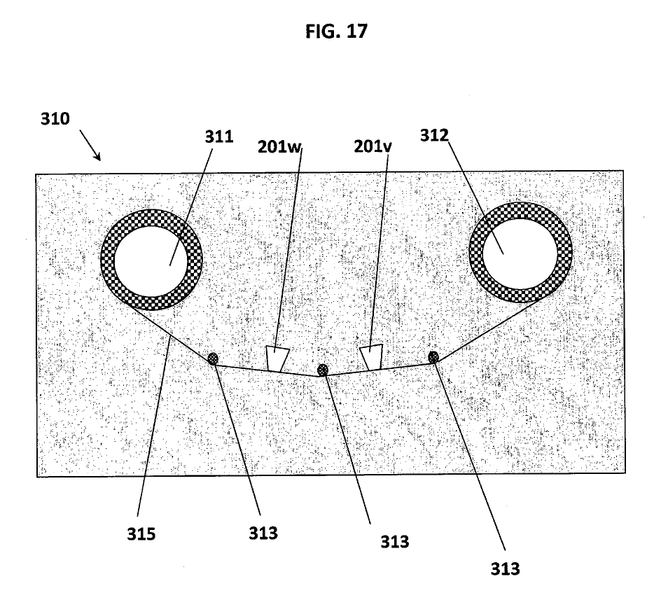

As shown in FIG. 17, a servo formatting system can include a head according to any one of the various embodiments of this disclosure mounted upon a production servo deck 310. The high efficiency surface film head as described herein may be designed for use as a servo write head 201w or as a servo verify head 201v, and positioned, as shown on the servo tape deck 310, in-between the supply reel 311 and the take up reel 312. Various tape guide elements 313 may be employed to guide the tape around the servo deck 310. The magnetic tape medium 315 is passed over the head or heads and formatted and/or verified according to the specification required for the product being produced. Other elements such as air-bearing spindles, vacuum columns, capstans, position error checker heads and many other sophisticated elements of the servo formatting deck are not shown for purposes of clarity.

Hence, it can be seen that embodiments of the present disclosure may provide for more efficient heads and allow the fabrication of narrower gaps in the surface of the head. Features of the present disclosure can be incorporated in both write and read heads. As discussed, a head having one or more features of the present disclosure can be used to write or format servo tracks on a tape media. For instance, a head can be part of a tape formatting device that receives and formats tapes with servo tracks or other data. Tape formatting devices can be formed utilizing one or more features of the present disclosure. A magnetic tape may be manufactured by a method utilizing one or more features of the present disclosure. In one example, servo information is written onto the magnetic tape using a servo head incorporating one or more features of the present disclosure. In one example, a method for formatting a tape media includes an operation of providing a head having a secondary sub gap having a shelf or mesa upon which a thin magnetic film carrying a recording gap feature or features is formed in the surface magnetic film head.

Embodiments of the present disclosure can be utilized with different data storage systems, and may be used with various different types of heads, including as examples but not limited to ferrite heads, thin film heads, Type I™ or Type II™ heads, or any other conventional head. For instance, the head may be a Type I™ head having a single ferrite channel, such as described in U.S. Pat. No. 5,689,384 entitled “Timing Based Servo System For Magnetic Tape Systems”; or a Type II™ head having multiple ferrite channels such as described in U.S. Pat. No. 6,496,328 entitled “Low Inductance, Ferrite Sub-Gap Substrate Structure For Surface Film Magnetic Recording Heads,” the disclosures of which are both incorporated by reference in their entirety.

Embodiments of the present disclosure may be applied to an integrated thin film surface head, such as described co-pending, commonly assigned U.S. Patent Application No. 60/568,139 entitled “Arbitrary Pattern Thin Film Surface Film Head” filed May 4, 2004, the disclosure of which is hereby incorporated by reference in its entirety.

While the methods disclosed herein have been described and shown with reference to particular operations performed in a particular order, it will be understood that these operations may be combined, sub-divided, or re-ordered to form equivalent methods without departing from the teachings of the present disclosure. Accordingly, unless specifically indicated herein, the order and grouping of the operations is not a limitation of the present disclosure.

It should be appreciated that reference throughout this specification to “one embodiment” or “an embodiment” or “one example” or “an example” or “another example” means that a particular feature, structure or characteristic described in connection with the embodiment may be included, if desired, in at least one embodiment of the present disclosure. Therefore, it should be appreciated that two or more references to “an embodiment” or “one embodiment” or “an alternative embodiment” or “one example” or “an example” in various portions of this specification are not necessarily all referring to the same embodiment. Furthermore, the particular features, structures or characteristics may be combined as desired in one or more embodiments of the disclosure.

While the various embodiments of the present disclosure have been particularly shown and described with reference to a preferred embodiment thereof, it will be understood by those skilled in the art that various other changes in the form and details may be made without departing from the spirit and scope of the disclosure.

We claim:

1. A surface film recording head comprising:
a surface formed by two magnetically permeable sub-poles separated by a substantially non-magnetic sub-gap;
one or more trenched regions formed into the surface, said trenched regions filled with a magnetically permeable material and extending from the sub-poles toward a gap pattern region in-between the sub-poles; and
a main surface film region extending over the magnetically filled trenched regions and spanning the gap pattern region, said main surface film having one or more magnetic recording gaps formed therein;
wherein the magnetically filled trenched regions serve to deliver magnetic flux to and from the main surface film containing the one or more recording gaps.

2. A method of forming a horizontally flux conducting magnetic sub-layer surface film head, the method comprising:
forming one or more trenches in a surface of a head substrate;
depositing a highly magnetically permeable material into the trenches;
planarizing or contouring the surface; and
depositing a highly magnetically permeable thin film layer on the planarized or contoured surface which spans the magnetically filled-in trenches;
forming gap patterns into the highly magnetically permeable thin film layer.

3. A method of formatting magnetic media comprising:
providing a magnetic recording head comprising:
a surface formed by two magnetically permeable sub-poles separated by a substantially non-magnetic sub-gap;
one or more trenched regions formed into the surface, said trenched regions filled with a magnetically permeable material and extending from the sub-poles toward a gap pattern region in-between the sub-poles; and
a main surface film region extending over the magnetically filled trenched regions and spanning the gap pattern region, said main surface film having one or more magnetic recording gaps formed therein;
passing the magnetic media over main surface film region; and
recording transitions onto the media via the recording gaps in the main surface film region.

4. A tape format deck comprising:
a supply reel;
a take up reel; and
the head of claim 1.

5. A magnetic recording media made by the head of claim 1.
